(19) United States
(12) Patent Application Publication
(10) Pub. No.: US 2026/0041976 A1
(43) Pub. Date: Feb. 12, 2026

(54) HYBRID THERMOFUSED PICKLEBALL PADDLE

(71) Applicant: Indian Industries, Inc., Evansville, IN (US)

(72) Inventor: Jay Simmons, Anthem, AZ (US)

(73) Assignee: Indian Industries, Inc., Evansville, IN (US)

(21) Appl. No.: 19/278,174

(22) Filed: Jul. 23, 2025

Related U.S. Application Data
(60) Provisional application No. 63/679,815, filed on Aug. 6, 2024.

(51) Int. Cl. A63B 59/42

(52) U.S. Cl. CPC A63B 59/42

(57) ABSTRACT

A pickleball paddle with a core including a first portion and a second portion. The first portion may define a first width between a first lateral side and a second lateral side of the paddle. The second portion may define a second width between the lateral sides of the paddle.

The paddle generally includes the core and a frame attached to the core. The core includes a first portion attached to the frame and a second portion positioned in the unframed portion. The frame defines a framed portion including the frame and the portions of the paddle between the frame. An unframed portion includes the remainder of the paddle. The first portion defines a first width less than a second width defined by the second portion. The core accommodates the frame around the first portion having the smaller width to promote a continuous transition between the framed and unframed portions.

### FIELD OF THE INVENTION

The present disclosure deals with paddles for ball games, in particular pickleball paddles.

### BACKGROUND

Pickleball is a racquet sport played with paddles and a perforated plastic ball on a court that is similar to a tennis court. Players hit the ball over a net placed on the ground, similar to tennis, with the goal of hitting the ball so the opposing player cannot return the shot.

Typically paddles used in pickleball may be made of metal, wood or composite materials. The construction and the weight characteristics of the paddle can have an effect on how a ball rebounds off of the paddle when a player hits a shot. When a player hits a ball near an edge of the paddle, the result of the shot is different than when the ball is hit near the center of the paddle. Often, when the ball is hit near the edge of the paddle, power on the shot is lost, while more power is generated when the ball is hit near the center of the paddle. Different players may prefer either more power or more control. Therefore, it is desirable to provide paddles that have different characteristics yet also have sufficient rigidity and strength.

Thus, there is a need for improvement in this field.

### SUMMARY

Certain embodiments include a paddle for playing pickleball. The paddle generally comprises a paddle blade core positioned in a blade of the paddle. The core generally includes a first portion and a second portion. The first portion is positioned toward a proximal end of the paddle, and the second portion is positioned toward a distal end of the paddle. Further, the first portion may define a first width between a first lateral side and a second lateral side of the paddle. The second portion may define a second width between the lateral sides of the paddle.

The core may further include a ledge positioned at the boundary between the first portion and the second portion. The first portion may define the first width adjacent to the ledge and on a proximal side of the ledge. Conversely, the second portion may define the second width adjacent to the ledge and on a distal side of the ledge. In one embodiment, the first width is less than the second width.

The core may be generally rectangular in shape with rounded corners. The first portion may define a first pair of parallel edges that extend along a length of the core on the lateral sides of the paddle. The first portion may define the first width between the first pair of parallel edges. Similarly, the second portion may define a second pair of parallel edges that extend along a length of the core on the lateral sides of the paddle. The second portion may define the second width between the second pair of parallel edges. In one version, the first pair of parallel edges extends between one fifth and one quarter of the length of the core.

The core may be formed from multiple cells arranged in a honeycomb pattern and may be shaped by cutting the core from a larger sheet of material. One or more cells along a perimeter of the core may be broken. The core optionally comprises foam within cells along the perimeter of the core.

The paddle may further comprise a frame attached to the core. The frame is generally positioned toward the proximal end of the paddle. In one version, the frame extends through a handle of the paddle and partially in the blade of the paddle. The frame may be positioned along the first portion of the core along the core perimeter. For instance, the frame may extend up to the ledge on said core. The frame and the core define a framed portion of the paddle that includes the frame and the first portion of the core. Generally, the framed portion may include the frame and the portions of the paddle between the frame. An unframed portion of the paddle extends beyond the frame toward the distal end of the paddle. The unframed portion may include the second portion of the core and generally the rest of the paddle besides the framed portion. The paddle may further include an edge guard attached to the blade of the paddle. The edge guard may extend along the unframed portion and around the second portion of the core.

The frame generally defines a frame thickness and the ledge of the core defines a ledge width. The edge guard may define an edge guard thickness. In one embodiment, the frame thickness approximates the combination of the edge guard thickness and the ledge width. In an alternate embodiment, the frame thickness approximates the ledge width. For instance, the frame thickness can approximate the ledge width and/or the combination of the edge guard thickness and the ledge width within 1 millimeter, 2 millimeters, 5 millimeters, and/or another value. Approximating the widths in such a way promotes a cohesive shape across the paddle.

In one version, the frame extends up to positions corresponding to 3 o'clock and 9 o'clock positions around the core perimeter, having the handle as a reference point at a 6 o'clock position. In another version, the frame extends up to positions corresponding to 5 o'clock and 7 o'clock positions around the core perimeter. In yet another version, the frame extends up to positions corresponding to 2 o'clock and 10 o'clock positions around the core perimeter

A method of making the pickleball paddle is also described. The method generally comprises wrapping a composite material around a length of a center tube to form an elongated roll. The elongated roll is then arranged along the core to form a paddle blank. The elongated roll is generally arranged adjacent the first portion of the core and not around the second portion of the core along the core perimeter. The paddle blank is then placed in a mold cavity of a mold.

After placing the paddle blank in the mold, the mold is heated. During the heating step, the composite material fuses into the frame. The frame generally forms an integrated piece with the center tube embedded in the frame. Further, the core typically attaches to the frame at this step to form a paddle body. The paddle body includes the handle and the blade, with the frame extending through the handle and partially in the blade, and with the core positioned in the blade.

The paddle body is then removed from the mold. After removal, the edge guard is attached to the paddle body around the second portion of the core along the core perimeter. As noted, the frame does not extend around the second portion of the core along the core perimeter. In one embodiment, the elongated roll includes a first roll and a second roll. The first roll is arranged along the core along the first lateral side, and the second roll is arranged along the core along the second lateral side. The frame may comprise two separate pieces. The pieces may each be formed by heating the first roll and the second roll.

In one version, the center tube is an inflatable tubular bladder, and the method includes additional steps. The method may further comprise attaching a compressed gas source to the inflatable tubular bladder. Then compressed gas may be supplied to inflate the elongated roll in the mold so that the composite material expands to fill the mold cavity.

Optionally, face shells may be attached on opposing faces of the paddle body before or after the paddle body is placed in the mold. Additionally, the edge guard may be attached to the paddle body along the core perimeter around the second portion of the core.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a pickleball paddle.

FIG. 2 is an exploded perspective view of the FIG. 1 paddle.

FIG. 3 is a perspective view of a core, a frame, and an edge guard, components of the FIG. 1 paddle.

FIG. 4 is a perspective view of the FIG. 3 core.

FIG. 5 is a front elevation view of the FIG. 3 core.

FIG. 6 is a perspective view of the FIG. 3 frame.

FIG. 7 is a top perspective view of the FIG. 3 core and frame.

FIG. 8 is a bottom perspective view of the FIG. 3 edge guard.

FIG. 9 is a top perspective view of the FIG. 3 edge guard.

FIG. 10 is a bottom perspective view of the FIG. 3 core and edge guard.

FIG. 11 is a perspective view of a composite material and a center tube used to make the FIG. 3 frame in one embodiment.

FIG. 12 is a perspective view of a roll comprising the FIG. 11 composite material and center tube.

FIG. 13 is a perspective view of a paddle blank comprising the FIG. 12 roll and FIG. 3 core.

FIG. 14 is a perspective view of a mold and a paddle body comprising the FIG. 3 core and frame.

FIG. 15 is a flowchart of a method for making the FIG. 1 paddle.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Directional terms, such as forward, rearward, top, bottom, etc., are used in this description with reference to the specific embodiment shown and used for purposes of clarity. It should be recognized that these terms are not meant to be limiting.

The present disclosure pertains generally to the field of paddles used for racquet sports such as pickleball. Aspects of the present disclosure include a core for such a paddle having a framed portion and an unframed portion. More specifically, the core includes a first portion and a second portion that define different widths. The paddle includes a frame that extends partially along a blade portion of the paddle and around the first portion of the core. The width of the second portion, optionally with an edge guard, approximates the combined width of the first portion and the frame to ensure a continuous paddle shape at the transition from the framed portion to the unframed portion.

The present disclosure further relates to a method of manufacturing such paddles. Aspects of the present disclosure include paddles formed using a plastic or composite molded material. More specifically, a sheet of composite material is wrapped around an inflatable bladder and placed in a mold. While heating the mold the bladder is inflated so that the composite material expands to fill the mold cavity. The material is then cured to form a rigid frame for a paddle. For example, U.S. Pat. No. 11,597,169 describes such a method for manufacturing a paddle frame. The frame may be wrapped around portions of the core before heating and curing, and the heating and curing step may fuse the frame to the core. Face shells and an edge guard are added to the core before or after the paddle blank and frame are placed in the mold to complete the paddle.

The International Federation of Pickleball (IFP) and USA Pickleball endorse rules of pickleball for tournament play and international competitions. The rules include equipment requirements that specify allowable paddle characteristics. A pickleball paddle must be constructed from a relatively rigid, non-compressible material. The hitting surface of the paddle cannot include holes, indentations, textured material, or any feature that applies additional spin to the ball. Rubber, synthetic rubber, sandpaper, moving parts that increase momentum, springs or spring-like material, and flexible membranes or compressive material that creates a trampoline effect are not allowed on the surface of the paddle.

The rigidity and compressibility of a paddle is determined using a deflection test. A common deflection test used to determine the rigidity of a paddle applies a force of 3 kg to the center of the paddle. The distance the paddle deflects due to the 3 kg force is recorded to provide a measurement of the paddle's rigidity. A paddle that has a deflection of 0.005 inches or less in the 3 kg test is considered to meet the rigidity specifications.

In addition to regulating the rigidity of a paddle, the IFP and USA Pickleball also specify size requirements. The combined length and width of a paddle cannot exceed 24 inches. These measurements include any additional length or width added by an edge guard or a butt cap added to the end of the handle. There are no restrictions on the weight of the paddle or the thickness of the paddle.

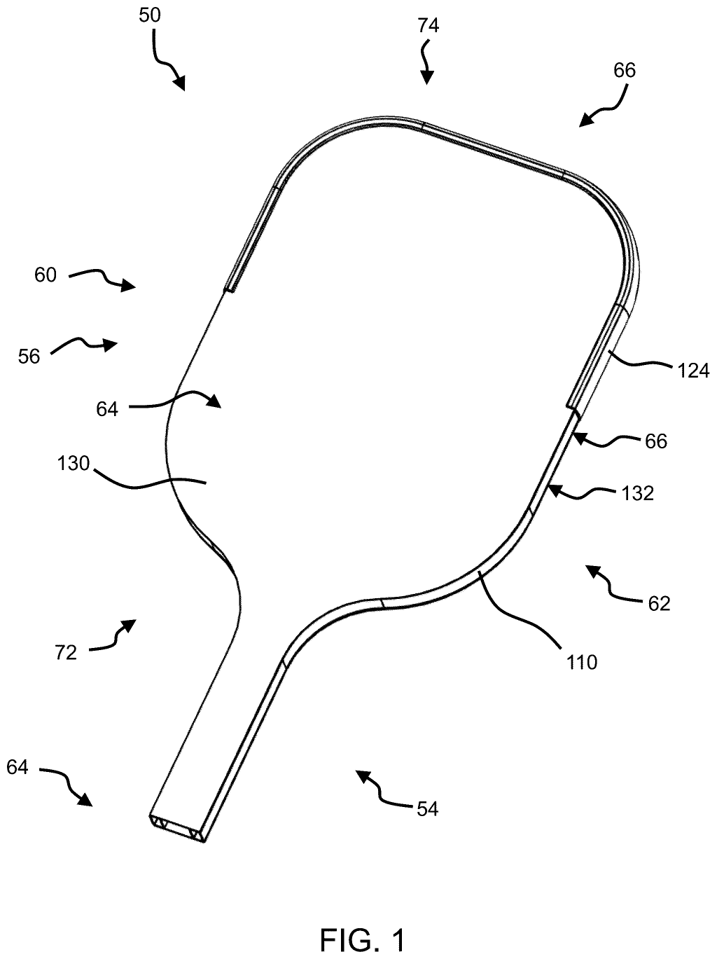

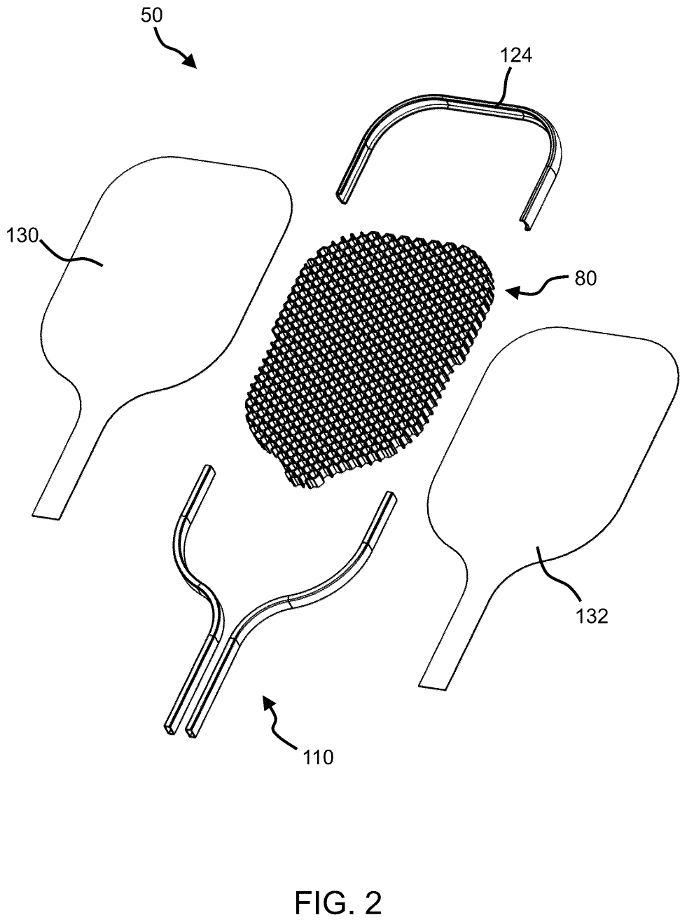

FIGS. 1 and 2 illustrate one embodiment of a pickleball paddle 50. The paddle 50 includes a handle 54 and a blade 56. The handle 54 is positioned toward a proximal end 64 of the paddle 50. The blade 56 is positioned toward a distal end 66 relative to the handle 54. The blade 56 is formed from a core 80, a frame 110, a front face shell 130, and a rear face shell 132. The frame 110 is generally positioned along portions of a first lateral side 60 and a second lateral side 62 of the paddle 50. An edge guard 124 may be positioned along a portion of the distal end 66 and lateral sides 60 and 62. The front shell 130 defines a planar front face 68 and the rear shell 132 defines a symmetric planar rear face 70. The faces 68, 70 are the parts of blade 56 that strike the ball during play.

It should be understood that the terms “front” and “rear” to describe the faces and shells are relative terms that describe the paddle as shown in the figures and are merely used for ease of description. Similarly, the terms “distal,” “proximal,” and “lateral” to describe the paddle are relative terms and are used for ease of description. In use, the orientation of the paddle and the faces is not important. The paddle may be held in any manner and either side of the paddle may be used to strike a playing object such as a pickleball.

The handle 54 optionally includes grips that are applied to the front and rear of the handle, such as panels, a wrap, or a thermoplastic overmolded foam as examples. The handle 54 may further include a handle cap attached to the proximal end 64.

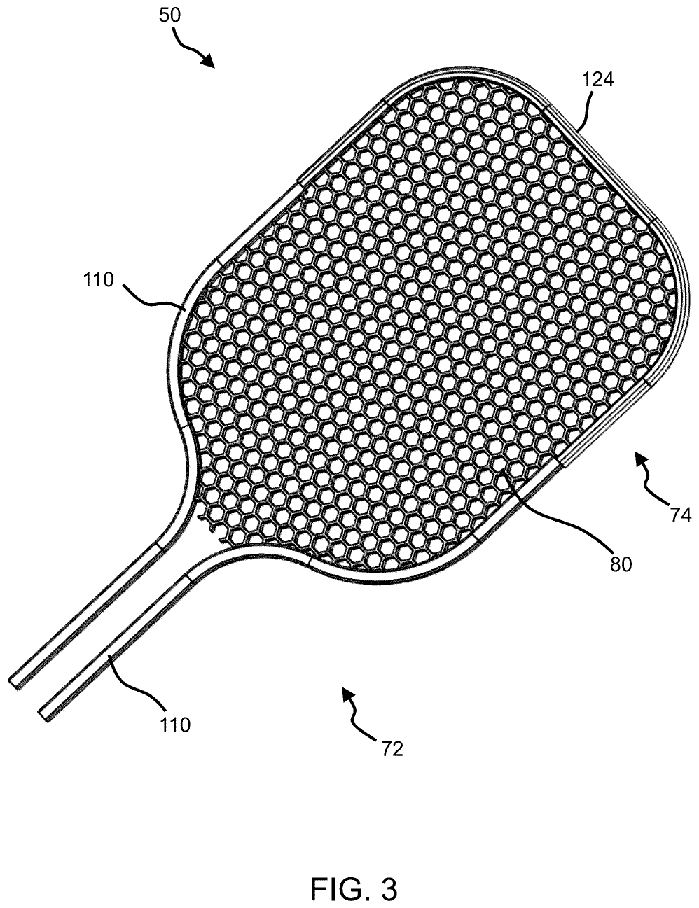

As illustrated in FIGS. 1, 2, and 3, the paddle 50 has a framed portion 72 and an unframed portion 74. The framed portion 72 includes the frame 110 and the parts of the paddle 50 positioned between the frame 110. The unframed portion 74 includes the remainder of the paddle 50. The frame 110 may extend along only part of the periphery of the paddle 50. In the illustrated example, the frame 110 extends through the handle 54 and partially in the blade 56.

Using a partially-framed paddle 50 may provide more control to users when hitting a ball compared to traditional framed paddles. A traditional frame that extends around the entire periphery of the paddle may make the paddle rigid and allow a user to rebound the ball with a large amount of power on hits. The partially-framed paddle 50 may allow the user to rebound the ball with a similar amount of power but with increased control. For instance, the unframed portion 74 may flex slightly to provide more control or “feel” to the user. The framed portion 72 may remain rigid to allow the paddle 50 to transfer high amounts of energy back to the ball on hits. When using the partially-framed paddle 50, a user may notice an increase in control and may not notice a decrease in power compared to using a traditional framed paddle.

In certain embodiments, the framed portion 72 extends from the three o'clock position to the nine o'clock position around the blade 56, using the handle 54 as a six o'clock position for reference. In alternate embodiments, the framed portion 72 extends from the five o'clock position to the seven o'clock position around the blade 56. In yet other embodiments, the framed portion 72 extends from the two o'clock position to the ten o'clock position around the blade 56. The edge guard 124 may extend exactly around the unframed portion 74, such as from the nine o'clock to three o'clock positions, seven o'clock to five o'clock positions, or ten o'clock to two o'clock positions as examples. Alternatively, the edge guard 124 may overlap with the frame 110 at one or more locations.

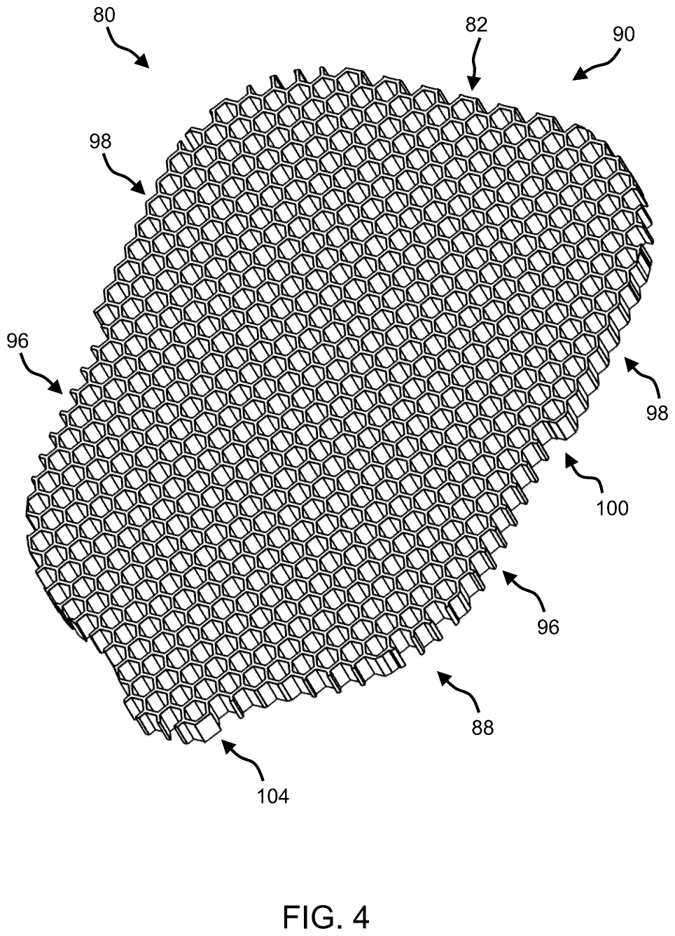

As illustrated in FIGS. 2-5, the core 80 may be shaped to allow the frame 110 to recess in a portion of the core 80. For example, the core 80 may be shaped differently near the framed portion 72 than the unframed portion 74 to accommodate the frame 110. The core 80 may extend to the periphery of the blade 56 at the unframed portion 74, but at the framed portion 72, the core 80 may be recessed so that the frame 110 extends around the core 80 and along the periphery of the blade 56. Shaping the core 80 in this way supports a cohesive overall shape for the paddle 50, particularly through the blade 56. The frame 110 may attach to the core 80 via adhesive, a fusing process, or in another way.

The core 80 is positioned within the blade 56 of the paddle 50 and provides the internal structure for the blade 56. The core 80 may be made of a generally rigid material, such as plastic. For instance, the core 80 may comprise polypropylene, carbon fiber, and/or another type of plastic material. In the illustrated embodiment, the core 80 is honeycomb-shaped with multiple hexagonal cells. Alternatively, the core 80 may be solid or utilize a different cell structure. The core 80 may be formed by cutting a desired shape from a larger sheet of material. For example, a waterjet, router, mill, and/or another tool may cut the core shape from a larger sheet of honeycomb material. Alternatively, the core 80 may be formed using a mold and/or another device. Forming the core 80 in such ways allows the core 80 to be formed with a specialized shape.

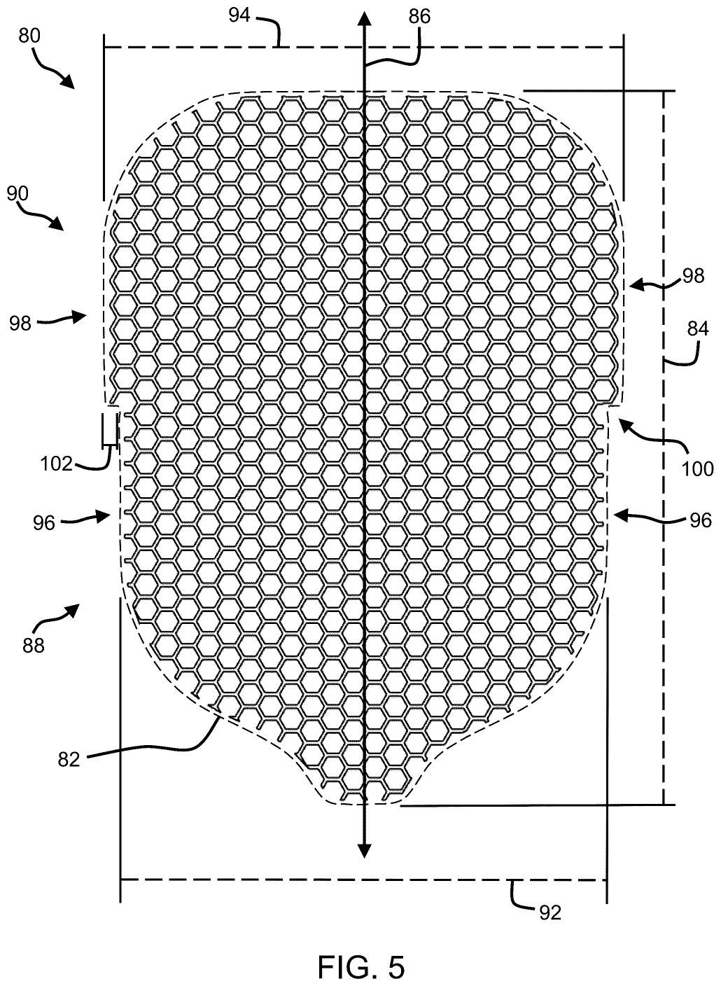

As illustrated in FIG. 5, the core 80 defines a core perimeter 82 around a periphery of the core 80. Because the core 80 may have multiple cells, such as in a hexagonal honeycomb structure, the outer periphery of the core 80 may be irregular and/or jagged where cells are cut. The core 80 may define the core perimeter 82 as an interpolated curve between points around the periphery. For example, the core perimeter 82 may be the path a waterjet and/or another tool follows to cut the core 80 from a sheet of material. The interpolated curve may mirror the shape of the frame 110 and/or the edge guard 124 where the frame 110 and/or the edge guard 124 attach to the core 80. Further, one or more cells around the core perimeter 82 may be broken. In other words, such cells may not fully enclose an area inside the cell within a plane extending through the core 80. Cells around the core perimeter 82 may be open or broken, the core 80 may include foam and/or another material to fill such cells. For example, cells along the core perimeter 82 may be filled with foam to create smooth and continuous sections along the core perimeter 82. Filling such cells may also prevent small pieces from rattling within the cut cells, such as residual fragments caused by cutting the core 80 via a waterjet or another tool. By filling cells around the core perimeter 82, the core 80 may have a cohesive shape and unwanted noise may be avoided.

The core 80 defines a core length 84 along a longitudinal axis 86. The longitudinal axis 86 generally extends from the proximal end 64 on the handle 54 to the distal end 66 on the blade 56. The core 80 further includes a first portion 88 and a second portion 90. Relative to the proximal end 64, the first portion 88 is positioned nearer than the second portion 90 along the longitudinal axis 86. The first and second portions 88 and 90 may be generally rectangular with curved segments around the corners. The first portion 88 may define a pair of parallel edges 96 on the lateral sides 60 and 62 of the core 80. The parallel edges 96 may extend along a length between one quarter and one fifth of the core length 84. Optionally, the parallel edges 96 may extend up to one third or up to one half of the core length 84. Similarly, the second portion 90 may define a second pair of parallel edges 98 on the lateral sides 60 and 62 of the core 80. The second pair of parallel edges 98 may extend a length between one quarter and one fifth, up to one third, or up to one half of the core length 84. The core 80 may be shaped in a variety of ways to support a variety of blade shapes on the paddle 50.

The core further defines a first width 92 and a second width 94. The first portion 88 defines the first width 92 and the second portion 90 defines the second width 94. The combined width of the first portion 88 and the frame 110 may approximate the second width 94 or the combined width of the second portion 90 and the edge guard 124. In this context, “approximate” can refer to having a difference within one percent of a total finished width of the paddle 50 and/or within 5 millimeters, 2 millimeters, 1 millimeter, or another small distance. In one example, the first portion 88 may define the first width 92 between the first pair of parallel edges 96, and the second portion 90 may define second width 94 between the second pair of parallel edges 98. The core 80 may include a ledge 100 at the boundary of the first portion 88 and the second portion 90. The first and second widths 92 and 94 may be defined by the first and second portions 88 and 90 immediately on either side of the ledge 100. For example, the first portion 88 may define the first width 92 on a proximal side of the ledge 100, and the second portion 90 may define the second width 94 on a distal side of the ledge 100. The ledge 100 defines a ledge width 102. The ledge width 102 may be half the difference between the first width 92 and the second width 94. For example, the core 80 may define equal ledge widths 102 on each lateral side 60, 62 of the core 80 at the boundary between the first and second portions 88 and 90.

The core optionally includes a throat portion 104. The throat portion 104 may extend into the boundary between the blade 56 and the handle 54 of the paddle 50. In the illustrated embodiment, the core 80 does not extend through the handle 54. Alternatively, the core 80 can be shaped to extend through all or part of the handle 54.

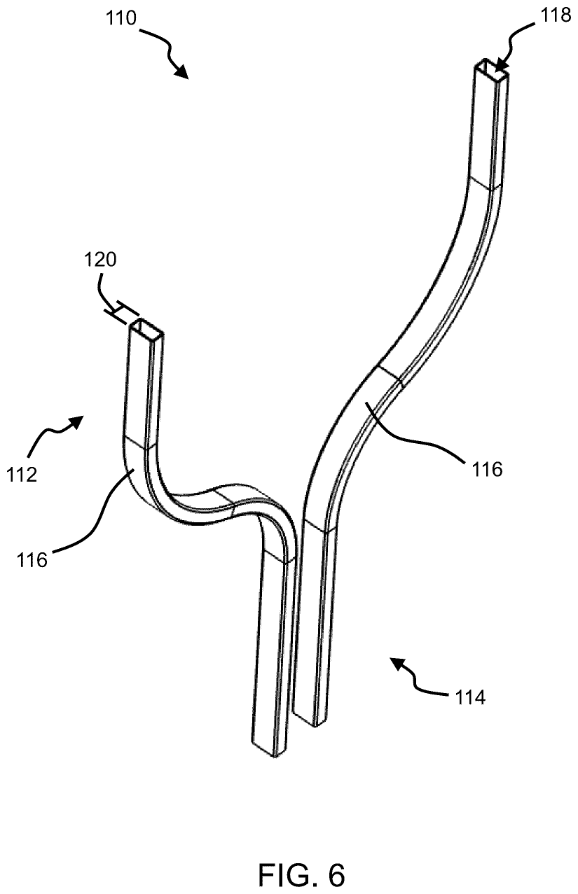

FIG. 6 illustrates frame 110 according to one embodiment. The frame 110 is generally rigid and includes a blade portion 112 and a handle portion 114. In the illustrated embodiment, the blade shape is generally rectangular with rounded corners and with the proximal portion tapering into the handle 54. Alternatively, the blade shape may be fully round, such as having a circular or ovular shape, or shaped in another way. The blade portion 112 is shaped to fit against the core 80 along a portion of the core perimeter 82, particularly around the first portion 88 of the core 80. Handle portion 114 is generally straight. In certain embodiments, the frame 110 is hollow and defines an interior channel 118.

In the illustrated embodiment, the frame is separated into two pieces 116. The pieces 116 may be identical in shape. For instance, the pieces 116 may be symmetric to each other across the longitudinal axis 86. Each piece may define an interior channel 118. Alternatively, the frame 110 may be a single piece. The pieces 116 may optionally be connected at one or more points in or continuously through the handle portion 114 to form a single piece frame 110. In one example, the handle 54 of the finished paddle 50 may be hollow with a space between the frame pieces 116. In another example, foam or another filler material may be added to the space between the frame pieces 116 in the handle 54.

The frame 110 defines a frame thickness 120 at the blade portion 112. In the illustrated example, the frame 110 defines a consistent frame thickness 120 through the blade portion 112 and handle portion 114. The frame thickness 120 may approximate the combined width of the edge guard 124 and the ledge 100 on the core 80. For example, the difference between the frame thickness 120 and the combined width of the ledge 100 and the edge guard 124 can be within 1 percent of the first width 92, the second width 94, and/or a total finished width of the paddle 50. As another example, this difference can be within 1 millimeter, 2 millimeters, 5 millimeters, and/or another value. By approximating the combined width of the ledge 100 and the edge guard 124, the frame thickness 120 allows the framed portion 72 and the unframed portion 74 to form a cohesive shape around the periphery of the blade 56.

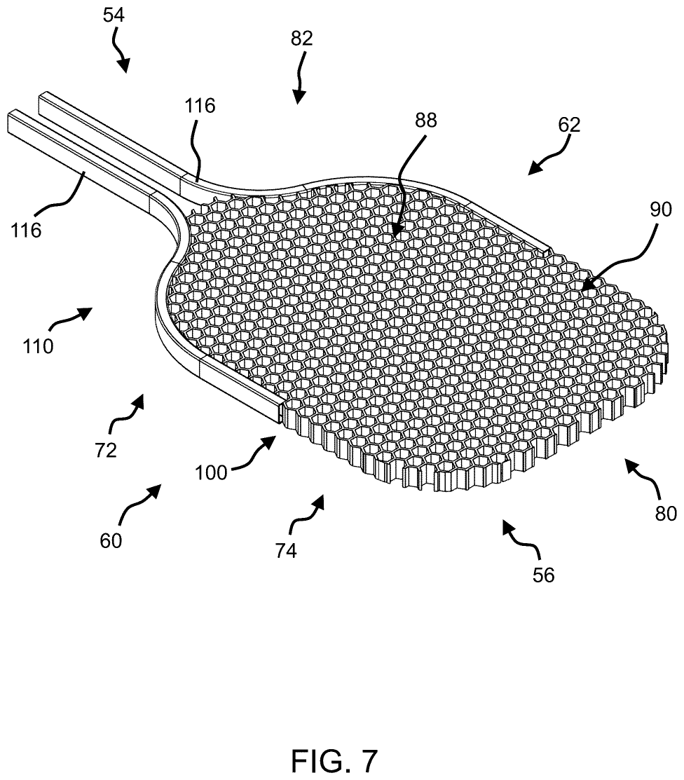

Alternatively, the frame thickness 120 may approximate the ledge width 102 to form a cohesive shape around the frame 110 and the core 80 before the edge guard 124 is attached. As shown in FIG. 7, the frame 110 may extend up to the ledge 100 on the core 80. The combined width of the frame 110 and the first portion 88 of the core 80 approximates the width of the second portion 90 of the core 80, optionally also including the thickness of edge guard 124. For example, the difference between the frame thickness 120 and the ledge width 102 can be within 1 percent of the first width 92, the second width 94, and/or a total finished width of the paddle 50. As another example, this difference can be within 1 millimeter, 2 millimeters, 5 millimeters, and/or another value. The framed portion 72 may smoothly transition and be flush with the unframed portion 74 and/or edge guard 124 to maintain a similar outward appearance to a traditional paddle.

In certain embodiments, the frame 110 may be formed of a graphite or composite material. “Graphite” or “composite” herein are intended to have their art recognized meanings, generally including fibers in a resin material. The fibers are typically made of graphite, carbon, glass, boron, synthetic fibers such as Kevlar®, fiberglass or other conventional materials. A composite sheet or prepreg sheet can be formed with fibers arranged in parallel and/or in a weave in a resin matrix. The frame 110 may be formed by heating and curing the composite material. In an alternative embodiment, the frame 110 is formed via subtractive manufacturing, such as by shaping material using a router, mill, waterjet, or another tool.

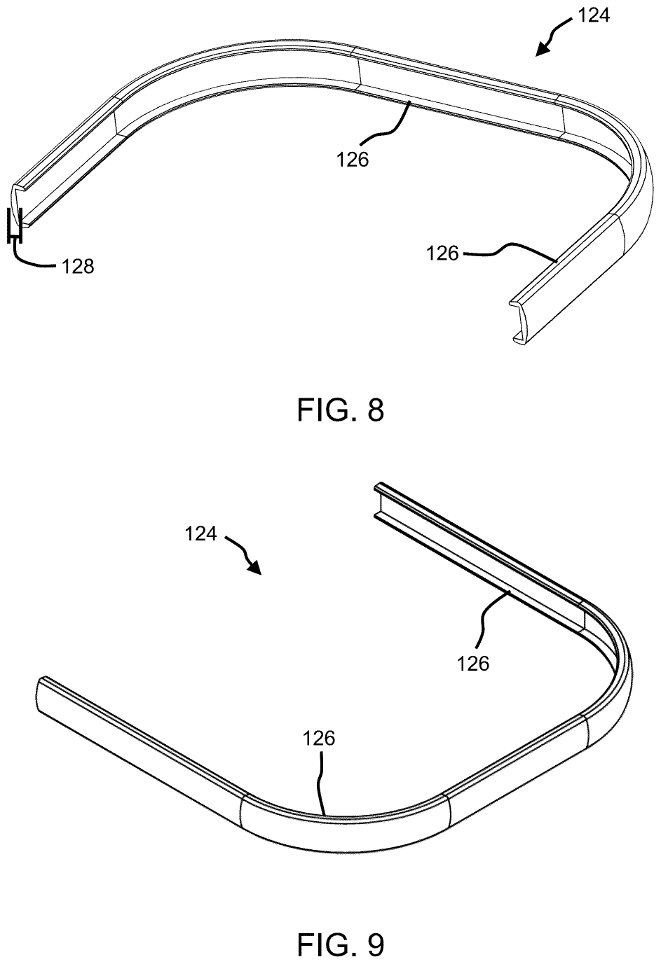

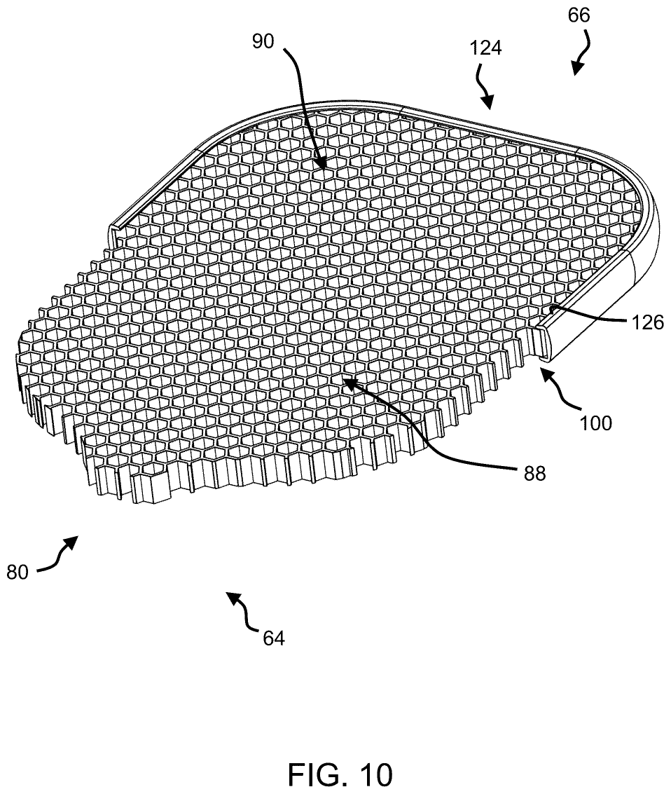

FIGS. 8 and 9 illustrate the edge guard 124 according to one embodiment. The edge guard 124 may be applied around the outer periphery of the blade. The edge guard 124 generally keeps the edge of the paddle from being damaged, particularly around the unframed portion 74. Because the core 80 may be exposed at the unframed portion 74, the edge guard 124 may protect the core 80 from being damaged. The edge guard 124 may be made of rubber, plastic, vinyl, silicone, or any other suitable material for protecting edge. In one embodiment, the edge guard 124 extends around the periphery of blade 56 only on the unframed portion 74. For example, as shown in FIG. 10, the edge guard 124 may be positioned around the second portion 90 of the core 80 along the core perimeter 82, but may not extend beyond the ledges 100 toward the proximal end 64. Alternatively, the edge guard 124 may extend substantially around the periphery of the blade 56 and not the handle 54, or may alternately cover selected locations.

The edge guard 124 may include a lip 126. The lip 126 may wrap around portions of the face shells 130 and 132 on the paddle 50. The lips 126 may help secure the edge guard 124 to the paddle 50 by providing additional surface area for adhesive to attach the edge guard 124 to the paddle 50.

The edge guard 124 defines an edge guard thickness 128. The edge guard thickness 128 may be relatively small compared to the widths 92 and 94 of the core 80. In certain embodiments, the edge guard thickness 128 approximates a difference between the frame thickness 120 and the ledge width 102. In such embodiments, the blade 56 defines a continuous shape at the transition between the frame 110 and the edge guard 124. Such an arrangement may facilitate attaching the edge guard 124 only on the unframed portion 74 and not the framed portion 72. In alternate embodiments, the frame thickness 120 and the ledge width 102 are approximately equal such that the frame 110 and the second portion 90 of the core 80 form a continuous shape at the transition between the two. For example, the boundary between the frame 110 and the core 90 on the periphery of the blade 56 may be smooth and continuous Such an arrangement may facilitate attaching the edge guard 124 around the unframed portion 74 and onto the framed portion 72.

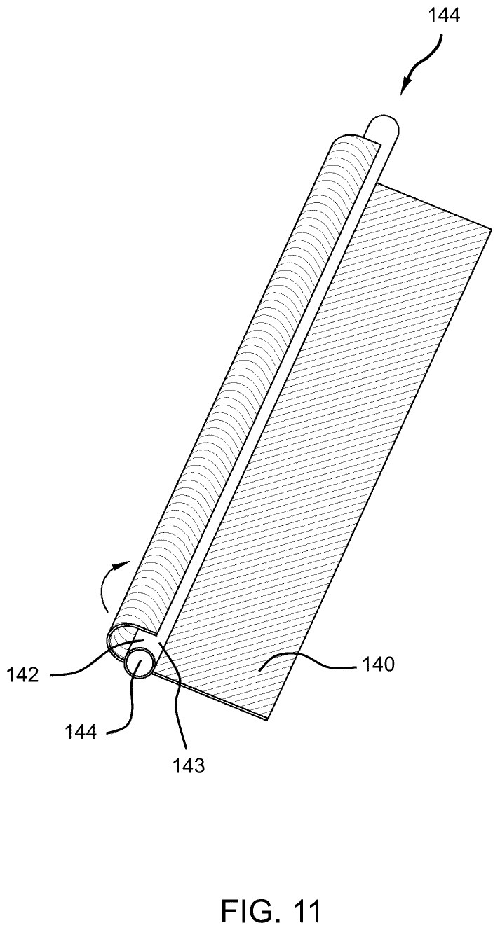

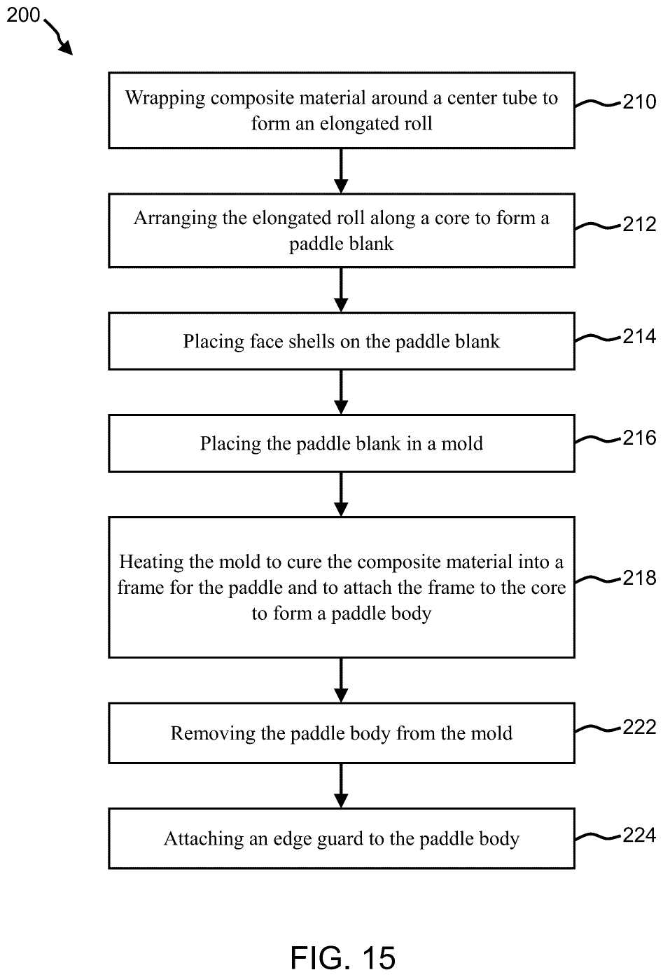

A method 200 of manufacturing the paddle 50 is illustrated and described in FIGS. 11-15. One or more steps of the method 200 may be performed manually by a human operator or in an automated way by a machine or device. As should be appreciated, various steps of the method 200 may be performed by different operators or machines.

As illustrated in FIG. 11, the process begins using a sheet of composite material 140 and a center tube 142. In a preferred embodiment, the center tube 142 is in the form of an inflatable tubular bladder 143. The bladder 143 preferably forms a hollow tube with an open end 144. The bladder 143 may be closed on the other end, optionally using a seal or a plug to close the end. In an alternate embodiment, the bladder 143 may be open on both ends 144. In another alternative embodiment, the center tube 142 may be polyurethane foam or another material arranged as a stripe or a solid or hollow tube.

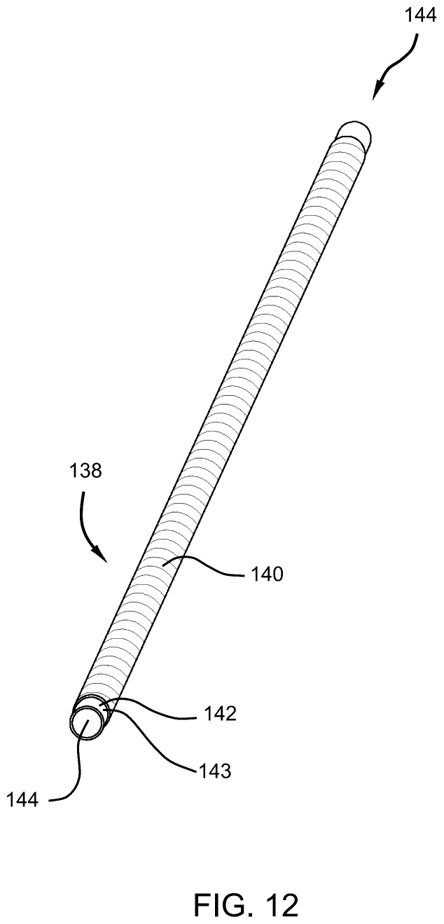

At stage 210, the composite material 140 is wrapped around the center tube 142. Initially, the center tube 142 is arranged lengthwise across the sheet of composite material 140. As shown in FIG. 12, the composite material 140 is then tightly rolled around the center tube 142 to form an elongated roll 138. The elongated roll 138 has a first end and a second end. Center tube ends 144 may slightly protrude from the ends of elongated roll 138, particularly in examples where the center tube 142 is the tubular bladder 143. In some embodiments, two elongated rolls 138 are formed for each paddle 50. For instance, one elongated roll 138 can be formed for each of the two frame pieces 116 shown in FIG. 6.

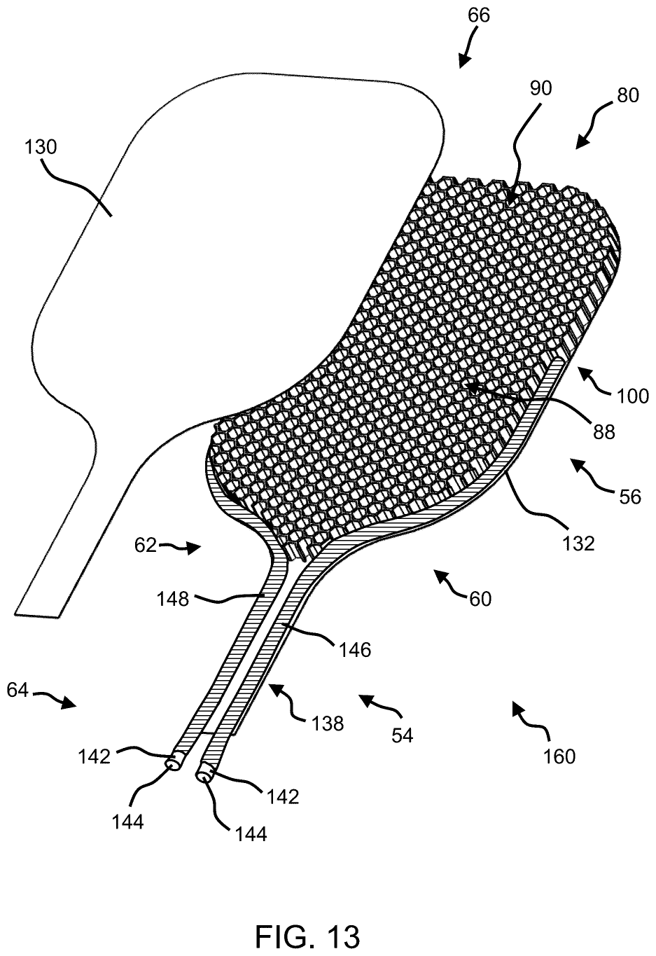

At stage 212, the roll 138 is arranged along the core 80 to form a paddle blank 160. As shown in FIG. 13, the roll 138 is positioned against the core 80 along the core perimeter 82. The rolls 138 may extend along the first segment of the core perimeter. For instance, the rolls 138 may be arranged against the ledge 100 of the core 80 and along the core perimeter 82 toward the proximal end 64. The length of the roll 138 extends beyond the core 80 toward the proximal end 64 to form the handle 54. In the illustrated embodiment, the paddle blank 160 includes a first elongated roll 146 arranged along the first lateral side 60 and a second elongated roll 148 arranged along the second lateral side 62. The rolls 146 and 148 each extend adjacent the first portion 88 of the core 80 and down the handle 54. The rolls 146 and 148 may be arranged symmetrically to one another across the longitudinal axis 86.

The open ends 144 of the rolls 146 and 148 may be positioned near the proximal end 64 of the paddle 50. In an example using a single roll 138, each end 144 of the roll 138 may be positioned adjacent the ledge 100 of the core 80 on either lateral side 60, 62. In such an example, the middle of the roll 138 may extend beyond the proximal end 64 of the paddle 50 and form a 180-degree curve.

At stage 214, the face shells 130 and 132 are placed on the paddle blank 160. As shown in FIG. 13, the face shells 130 and 132 may be placed on the core 80 and the elongated rolls 138 before the frame 110 is formed through a heating and curing step. In another embodiment, the face shells 130 and 132 may be attached to the core 80 at another point in the manufacturing process, such as after heating and curing the frame 110. Face shells 130 and 132 may be secured using adhesive or a fusing process. Alternatively, fasteners may be used.

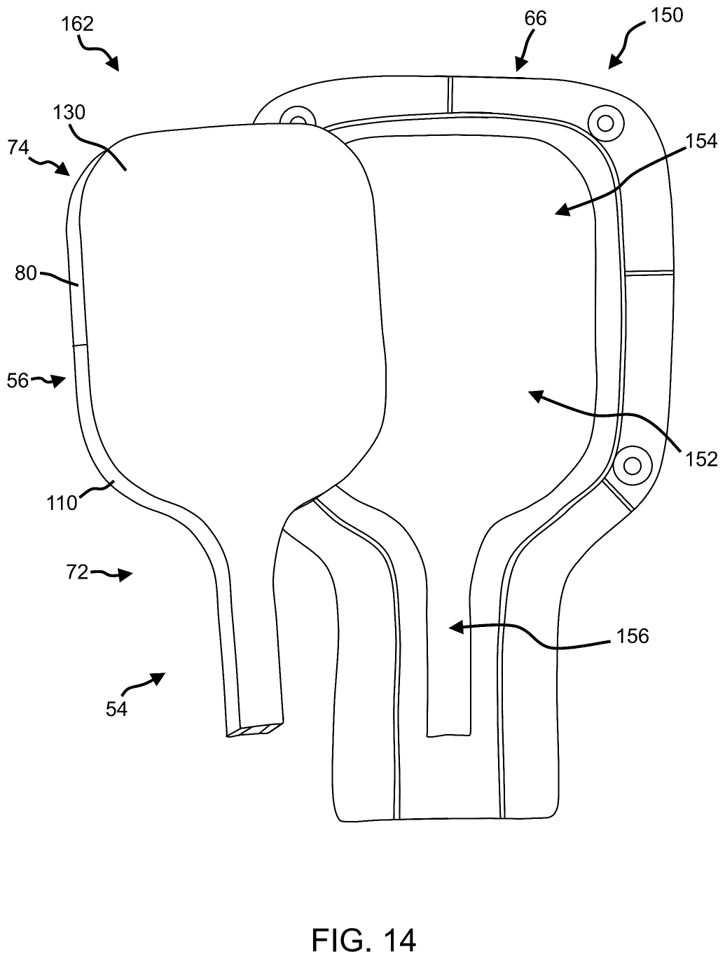

At stage 216, the paddle blank 160 is placed in a mold 150. In the embodiment shown in FIG. 14, the mold 150 defines a mold cavity 152 with a blade cavity 154 and a handle cavity 156. The mold 150 may be a two-part mold having a top and bottom that interface while closing. The paddle blank 160 may be placed in the mold cavity 152 with the rolls 138 positioned in both the blade cavity 154 and handle cavity 156. The core 80 may be positioned in the blade cavity 154. In an alternate embodiment, the mold 150 may define channels that receive the rolls 138 and that shape the rolls 138 into the final shape of the frame 110. The method 200 may optionally include multiple molds and molding steps. For example, in some embodiments, the rolls 138 may be placed in a first mold to form the frame 110, and then the core 80, the frame 110, and optionally the face shells 130 and 132 may be placed in a second mold for a second molding and/or fusing step. The ends of the roll and/or the bladder ends 144 may slightly protrude from mold 150, such as from the handle cavity 156.

At stage 218, the mold 150 is heated. Heating the mold 150 causes the composite material 140 in the roll 138 to fuse and form the frame 110. In a preferred embodiment, a compressed gas source is attached to the open ends 144 of the bladders 143. In an example with a single roll 138 and bladder 143, the compressed gas source may be connected at only one end 144. The compressed gas may be ambient air or an inert or non-reactive gas. As the mold 150 is heated, the compressed gas inflates the bladder 143 to stretch the composite material 140 and conform the shape of the composite material 140 to the mold cavity 152. The composite material 140 expands against the core 80, the mold 150, and optionally the face shells 130 and 132. In an alternate embodiment, the roll 138 is placed in a separate mold first to be heated and inflated to form the frame 110. The composite material 140 is then cured and fused to form the frame 110 as shown in FIG. 14. The bladder 143 may melt during this process, leaving the interior channel 118 and channel openings in the frame 110. In an alternate embodiment, the center tube 142 in the roll 138 may be a foam center, and heating the mold 150 causes the composite material 140 to fuse with the foam center and to form the frame 110 as an integrated piece.

During the heating step in stage 218, the frame 110 is attached to the core 80 to form a paddle body 162. Heating the mold 150 may fuse the frame 110 to the core 80, or optionally the core 80 may attach to the frame 110 in another way. In an alternate embodiment, the frame 110 may fuse to the core 80 in a separate heating step, such as using a different mold than the previous step. In yet another example, the core 80 can be attached to the frame 110 at a separate step using adhesive or even fasteners. Similarly, the face shells 130 and 132 may be fused to the paddle body 162 at the heating step in stage 218. In an alternative embodiment, the face shells 130 and 132 may attach to the paddle body 162 in a separate step.

After the curing process is complete, the paddle body 162 is removed from the mold 150 at stage 222. The paddle body 162 is then allowed to cool outside the mold 150. In some embodiments, the interior channels 118 left by the bladder 143 in the completed frame 110 are left empty. In other embodiments, the channels 118 may be filled with a filler material, such as foam, rubber, or silicone. Filler material may be used to provide additional support to paddle 50 and may also dampen sound or vibration when a playing object, such as a pickleball, is struck by the paddle 50. Further, the paddle body 162 may be puttied and/or sanded to smooth any imperfections on the faces 68 and 70. Paint and/or a decal may be added to the faces 68, 70 after puttying or sanding.

At stage 224, the edge guard 124 is attached to the paddle body 162. In the illustrated embodiment, the edge guard 124 is attached after the face shells 130 and 132 are added to the paddle 50. The edge guard 124 may be attached using adhesive or a fusing process. In an alternate example, the edge guard 124 may be attached before the face shells 130 and 132.

Optionally, grips may be added to the handle 54, such as in the form of panels, a wrap, or overmolded foam.

According to any of the embodiments herein, the playing characteristics of the paddle 50 can be selected or customized depending on the arrangement of the frame 110. The shape of the frame may affect the weight distribution along the paddle 50. When the frame 110 extends up to the 9 o'clock and 3 o'clock positions on the blade 56, using the handle 54 as the 6 o'clock position for reference, the paddle 50 may have a certain balance point and rebound characteristics. Using a frame 110 that extends to the 7 o'clock and 5 o'clock positions on the blade 56 may alter the balance point and rebound characteristics of the paddle 50. For instance, the sweet spot may be closer to the proximal end 64 of the paddle 50 when using the 5 o'clock to 7 o'clock frame than when using the 3 o'clock to 9 o'clock frame. As another example, the sweet spot may be closer to the distal end 66 when using a frame that extends to the 10 o'clock and 2 o'clock positions. Generally, greater rebound energy is transferred to a ball when hit at the sweet spot compared to other portions of the paddle. Moving the balance point of the paddle 50 moves the sweet spot of the paddle. Adjusting the ratio of the framed portion 72 to the unframed portion 74 on the paddle 50 can affect the balance point and the sweet spot. Players may select a paddle having the optimal combination of framed and unframed portions so as to move the sweet spot to an optimal location for that player.

Adjusting the material of the frame 110 may further tune the balance and rebound characteristics of the paddle 50. Using a larger framed portion 72 relative to the unframed portion 74 may increase the rigidity of the paddle 50. Increasing the rigidity of the paddle 50 allows the paddle 50 to transfer more rebound energy to the ball and to generate a higher power shot. Less rigidity may exchange some power to allow the player to have greater control.

Optionally, the material of the frame 110 may be altered to be more or less rigid at one or more locations. In certain embodiments, the material composition of the frame 110 may be varied by changing the material along the elongated roll 138 or by adding more material at precise locations along the elongated roll 138. Optionally, materials such as fiberglass, Kevlar type fibers, or ceramics can be added to selected portions of the roll 138 to affect the strength, rigidity, flexibility, density or other characteristics.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

1. A pickleball paddle, comprising:
a core positioned in a blade of said paddle, said core comprising:
a first portion positioned toward a proximal end of said paddle, said first portion defining a first width from a first lateral side to a second lateral side of said paddle;
a second portion positioned toward a distal end from said first portion, said second portion defining a second width from said first lateral side to said second lateral side; and
a ledge positioned at a boundary between said first portion and said second portion;
wherein said first portion defines said first width adjacent to and on a proximal side of said ledge;
wherein said second portion defines said second width adjacent to and on a distal side of said ledge; and
wherein said first width is less than said second width.

2. The paddle of claim 1, wherein said core is formed from multiple cells arranged in a honeycomb pattern; wherein said core is shaped by cutting said core from a larger sheet of material; and wherein one or more cells positioned along a perimeter of said core are broken.

3. The paddle of claim 2, wherein said core comprises foam within cells along said perimeter of said core.

4. The paddle of claim 1, wherein said first portion defines a first pair of parallel edges on said first and second lateral sides that extend along a length of said core;
wherein said first portion defines said first width between said first pair of parallel edges;
wherein said second portion defines a second pair of parallel edges on said first and second lateral sides that extend along said length of said core; and
wherein said second portion defines said second width between said second pair of parallel edges.

5. The paddle of claim 4, wherein said first pair of parallel edges extends between one fifth and one quarter of said length of said core.

6. The paddle of claim 1, further comprising:
a frame attached to said core, said frame positioned toward said proximal end of said paddle, wherein said frame is positioned adjacent said first portion of said core and extends up to said ledge on said core;
wherein said frame and said core define a framed portion of said paddle including said frame and said first portion of said core; and
wherein said second portion of said core defines an unframed portion of said paddle, said unframed portion extending beyond said frame toward said distal end of said paddle.

7. The paddle of claim 6, further comprising:
an edge guard attached to said blade of said paddle, wherein said edge guard extends along said unframed portion and around said second portion of said core.

8. The paddle of claim 7, wherein said frame defines a frame thickness, wherein said ledge defines a ledge width, and wherein said edge guard defines an edge guard thickness;
wherein said frame thickness approximates the combination of said ledge width and said edge guard thickness within one percent of a total finished width of the paddle.

9. A pickleball paddle, comprising:
a paddle blade core, said core extending across a paddle blade, wherein said paddle blade core defines a core perimeter and has a first portion and a second portion; and
a frame, wherein said frame extends into a paddle handle toward a proximal end of said paddle and partially into said paddle blade, and wherein said frame is attached to said paddle blade core along said core perimeter at said first portion of said core;
wherein said frame defines a framed portion of said paddle including said frame and said area of said paddle positioned between said frame; and
wherein an unframed portion of said paddle extends beyond said frame toward a distal end of said paddle, said unframed portion including said remainder of said paddle not in said framed portion, and said unframed portion including said second portion of said core.

10. The paddle of claim 9, wherein said core defines a first width at said first portion and a second width at said second portion; and wherein said first width is less than said second width.

11. The paddle of claim 10, wherein said core includes a ledge at a boundary between said first portion and said second portion; wherein said ledge defines a ledge width; wherein said frame defines a frame thickness; and wherein said ledge width approximates said frame thickness within one percent of a total finished width of the paddle.

12. The paddle of claim 9, comprising an edge guard, wherein said edge guard is attached to said second portion of said core and positioned along said unframed portion of said paddle.

13. The paddle of claim 9, wherein, with said handle as a reference point at a 6 o'clock position, said frame extends up to positions corresponding to 3 o'clock and 9 o'clock positions around said core perimeter.

14. A method of making a pickleball paddle, comprising:
wrapping a composite material around a length of a center tube to form an elongated roll;
arranging said elongated roll along a paddle blade core to form a paddle blank, said paddle blade core having a first portion and a second portion and defining a core perimeter, wherein said elongated roll is arranged adjacent said first portion of said core and not around said second portion of said core along said core perimeter;
placing said paddle blank in a mold cavity of a mold;
heating said mold to fuse said composite material into a frame, forming an integrated piece with said center tube embedded in said frame, and attaching said paddle blade core to said frame to form a paddle body, wherein said paddle body has a handle and a paddle blade, wherein said frame extends through said handle and partially into said paddle blade, wherein said paddle blade core is positioned in said paddle blade, and wherein said frame does not extend along said core perimeter at said second portion of said paddle blade core;
removing said paddle body from said mold; and
attaching an edge guard to said paddle body along said second portion of said core perimeter.

15. The method of claim 14, wherein, with said handle as a reference point at a 6 o'clock position, said frame extends up to positions corresponding to 3 o'clock and 9 o'clock positions around said core perimeter.

16. The method of claim 14, wherein said paddle blade core defines a ledge at a boundary between said first portion and said second portion; and wherein an end of said elongated tube is arranged adjacent to said ledge.

17. The method of claim 14, wherein the elongated roll includes a first roll and a second roll, and wherein said first roll is arranged along said paddle blade core along a first lateral side, and wherein said second roll is arranged along said paddle blade core along a second lateral side.

18. The method of claim 17, wherein said frame comprises two separate pieces, said pieces being formed by heating said first roll and said second roll.

19. The method of claim 14, wherein said center tube is an inflatable tubular bladder, and comprising:
attaching a compressed gas source to said inflatable tubular bladder; and
supplying compressed gas to inflate said elongated roll in said mold so that said composite material expands to fill a mold cavity.

20. The method of claim 14, comprising:
mounting face shells on opposing faces of said paddle body; and
attaching an edge guard to said paddle body along said core perimeter around said second portion of said paddle blade core.
